(19) United States
(12) Patent Application Publication
(10) Pub. No.: US 2011/0109087 A1
(43) Pub. Date: May 12, 2011

(54) GEOTHERMAL POWER PLANT

(76) Inventors: Skuli Johansson, Oslo (NO); Gudmundur Thor Thormodsson, Oslo (NO); Stig Torvund, Oslo (NO)

(21) Appl. No.: 12/922,536

(22) PCT Filed: Mar. 17, 2009
(86) PCT No.: PCT/NO09/00100

§ 371 Date: Jan. 20, 2011

(30) Foreign Application Priority Data
Mar. 17, 2008 (NO) 20081397

(51) Int. Cl. H02K 7/18; F03G 7/00

(52) U.S. Cl. 290/52; 60/641.4

(57) ABSTRACT

Geothermal power plant, comprising units that are modularized and adapted in order to fit into one or more container, as a geothermal container unit, the geothermal container unit is dimensioned in order to be adapted to extract geothermal energy from one drillbore, and each geothermal container unit has means for being electrically connected to other geothermal container units as well as electric power network, thereby providing a geothermal power plant arranged in a network providing load balancing and redundancy.

### FIELD OF THE INVENTION

The present invention relates to geothermal power plants. More specifically, the invention relates to a geothermal power plant providing technical and commercial advantages over state of the art geothermal power plants, particularly when geothermal drill holes are situated over a large area.

### BACKGROUND OF THE INVENTION AND PRIOR ART

Geothermal power is energy generated from heat stored in the earth, or the collection of absorbed heat derived from underground. Currently most common types of geothermal power plants are flash and then binary cycle plants. Binary cycle power plants pass moderately hot geothermal water by a secondary fluid with a much lower boiling point than water, which secondary fluid thereby evaporates and drives turbines. Flash type is the most common where the high temperature steam is taken directly from bore well and fed to the turbine which drives the generator. Enhanced Geothermal Systems (EGS) is a new alternative geothermal technology. EGS typically uses deep that wells into hot rock in order to inject water and use returning steam to generate power.

Current geothermal power plants are designed as centralized power plants in between a number of well bores that can be at maximum ca. 2 kilometres from the power plant, and on-surface steam pipes are typically arranged to lead the steam to the centralized power plant. All geothermal power projects begin with exploration phase where the most promising locations are chosen. Thereafter starts a drilling phase at the chosen location and then drilling plan is made for example for an estimated 50 MW. Drilling of production boreholes is then started where a typical hole has 5 MW power or less. Drilling of each hole takes usually 2-4 months time and then the drilling rig is moved to the next location. In the case of 50 MW the number of boreholes may be 10 and it could take as long 3 years to drill them all. After which an evaluation/design phase begins (1-2 years) and then construction (1-3 years) phase. Only after that electricity production can begin. During all that period of time the already finished boreholes are idle and no income from sale of electrical power is generated. Time from the first hole is ready till construction is finished is typically 6 years. The average cost for a 5 MW hole may be in the region of 3-4 Million USD. Thus a huge investment is left idle for up to 6 years.

As per above investments are high, the start of payback is late and the redundancy and versatility with respect to load balancing is limited. More specifically, the design to operation period is typical 6-10 years, start of payback is typically from year 7-9 and the redundancy is limited in case of well reduced power output. Further, engineering is borious and expensive because every plant is tailor made, which is complex and expensive. Furthermore well bores must be near the centralized power plant in order to avoid excessive pressure losses and condensing of steam in the pipes. Also, the impact on the environment is negative with large power structures and unsightly piping.

There is a demand for a geothermal power plant having beneficial properties with respect to the above mentioned disadvantages.

### SUMMARY OF THE INVENTION

The above-mentioned demand is met by the present invention, which avoids or reduces the above-mentioned disadvantages.

More specifically, the present invention provides a geothermal power plant, distinguished in that it comprises units that are modularized and adapted in order to fit into one container or more containers, as geothermal container units,

the geothermal container units are dimensioned in order to be adapted to extract geothermal energy from one drill bore or that of an average hole, and

each geothermal container unit has means for being electrically connected to other geothermal container units as well as electric power network, thereby providing a geothermal power plant arranged in a network providing load balancing and redundancy.

The geothermal power plant can be either flash or binary cycle.

In one preferred embodiment the invention is a flash/binary cycle geothermal power plant comprising,
1. a steam/brine processing unit, operatively coupled to
2. a turbine/generator unit, operatively coupled to
3. a condensing unit, operatively coupled to
4. a cooling tower unit,
   distinguished in that

said units are modularized and adapted in order to fit into one or more standard containers, as a geothermal container unit,

the geothermal container units are dimensioned in order to be adapted to extract geothermal energy from mainly one borehole, and

each geothermal container unit has means for being electrically connected to other geothermal container units as well as electric power network, thereby providing a geothermal power plant arranged in a network providing load balancing and redundancy.

Preferably, each modular and containerized unit is placed next to or in close vicinity of a respective borehole platform (wellbore, drill bore, drill hole), avoiding transport of steam and resulting pressure losses and environmental disadvantages. Preferably the electrical cables for interconnecting the geothermal containerized units are buried in order to reduce the environmental impact. A typical containerized unit is preferably dimensioned to be arranged for 5 MW installed capacity, however, fully adaptable to the capacity obtainable from the local well bores, one or more.

Preferably the geothermal power plant is arranged in a peer-to-peer network providing remote monitoring and control. The remote management tools centralize control and maximize plant productivity. This comprises preventive maintenance sensors and software in order to reduce risk of failure. Preferably all units comprise additional turbine rotor with blades, which onsite easily can be used to replace damaged turbine rotors. The decentralized network provides complete redundancy against failure. The deliverable will be electrical power from about 5 MW up to 50 MW or above, collecting geothermal energy from a much larger area than the traditional area that is within a radius of ca. 2 km from a central power plant. The modular design enables the power plant to be highly scalable, and adaptable to local demand.

Calculations indicate that the power producers will pay back the entire on surface investment typically within 4 to 6 years using either average European spot market prices of 2008 for electricity or the feed-in tariff of 01.01.2009 for geothermal green energy in Germany. The price per megawatt installed is highly competitive on the market. Delivery time will be only about 7-9 months from date of order. Further, the modularized design allows and facilitates replacement with newer and more efficient modular units or parts as the technology improves. This applies also when borehole power is reduced as the geothermal units are easily transportable and dimensioned in standardized shipping containers. This additional risk management in geothermal power projects is of considerably high investment value.

### FIGURES

The present invention is illustrated by several figures, of which:

FIG. 1 illustrates the components of a single geothermal container unit

FIG. 2 illustrates the several geothermal units comprising a geothermal power system

FIG. 3a illustrates a the plan for a conventional geothermal power plant,

FIG. 3b illustrates the plan for a state of the art geothermal power system according to the invention

FIG. 4 illustrates 6 years earlier start up time of a typical geothermal power project compared to a state of the art geothermal power system according to the invention

FIG. 5 illustrates the earlier payback of a state of the art geothermal power system according to the invention compared to a conventional geothermal power plant

### DETAILED DESCRIPTION

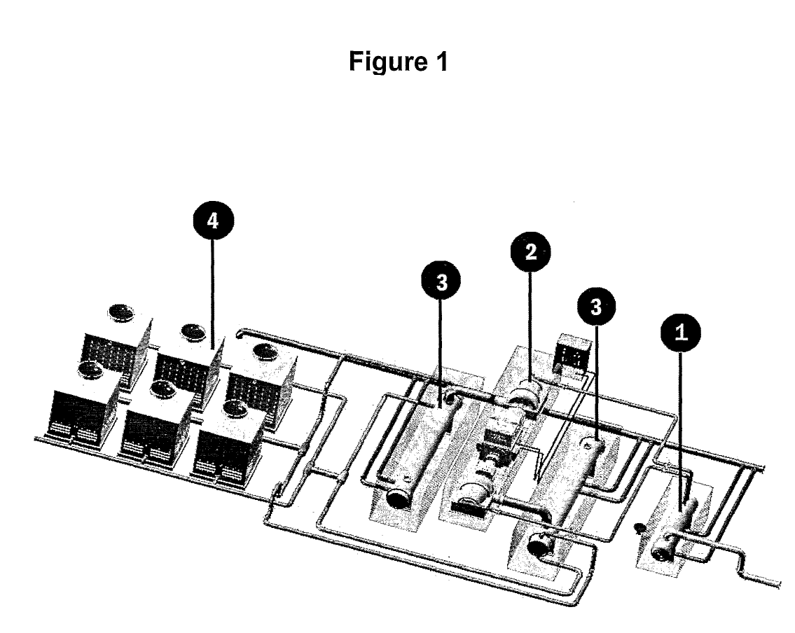

Reference is first made to FIG. 1, illustrating a geothermal power system according to the present invention, more specifically a geothermal container unit according to the present invention. More specifically, FIG. 1 illustrates the contents of a flash/binary cycle geothermal container units comprising of a steam processing unit 1 (comprises steam and moisture separator for the flash type systems and evaporator for binary type systems), which is operatively coupled to a turbine/generator unit 2, a condensing unit 3 and a cooling tower 4.

Every part of the geothermal power plant of the invention can comprise of prior art technology, but the assembly thereof is providing a surprising technical and economical beneficial effect. However, new and improved technology is preferably used or replacing older technology as the technology develops further.

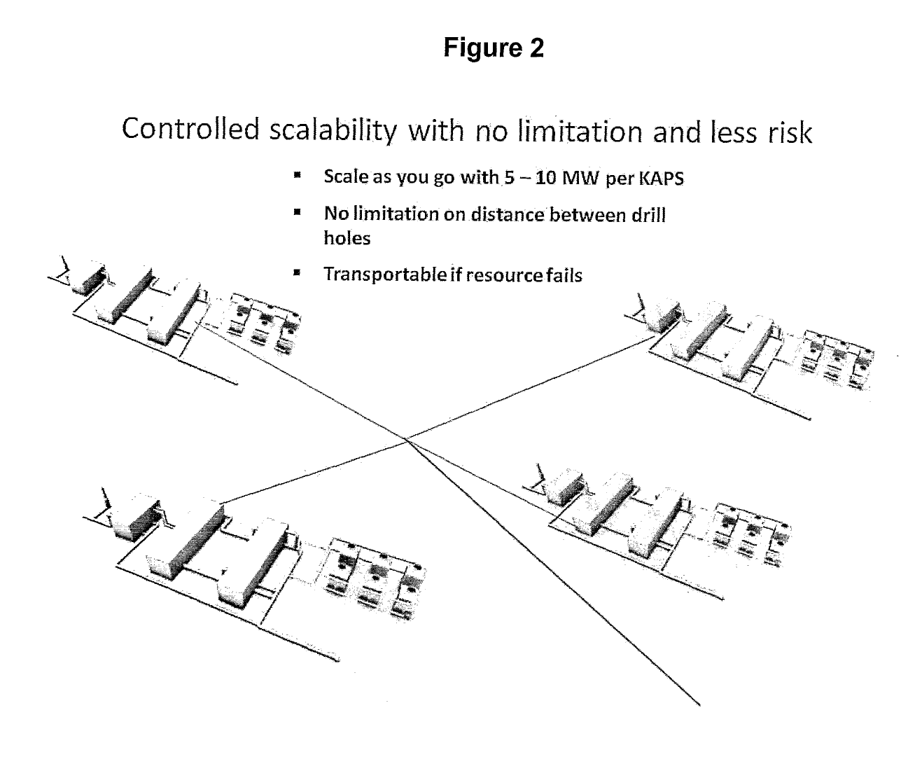

FIG. 2 is a plan illustrating in further detail how the geothermal power system of the present invention is assembled from several containerized units

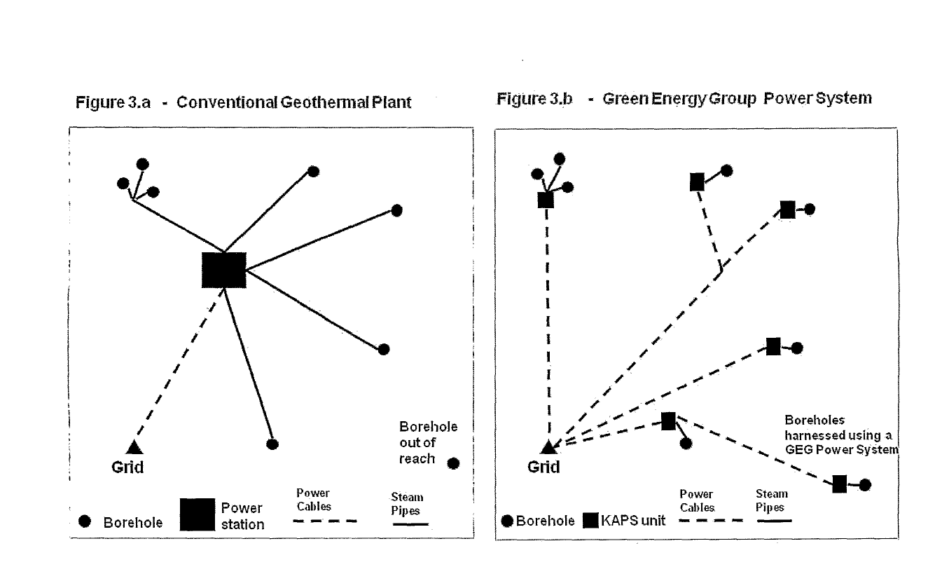

FIG. 3a illustrates the current geothermal power plant technology, illustrating the centralized power plant and how it is connected to surrounding bore holes each being no further away than 2 km, the connection compriseing of on-surface steam pipes.

FIG. 3b illustrates the plan for a state of the art geothermal power system according to the invention, illustrating the network of geothermal container units distributed on larger area.

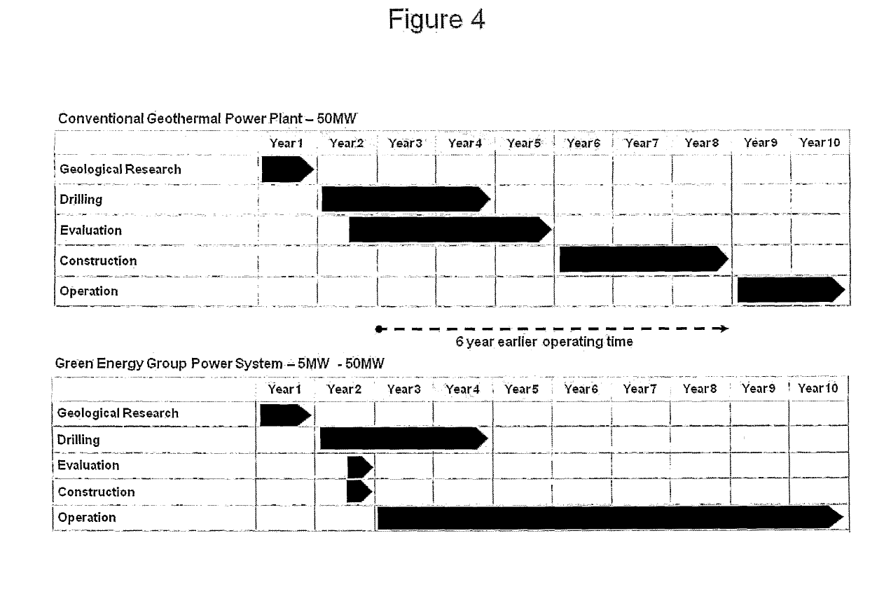

FIG. 4 illustrates the timeline for conventional geothermal power plant project and the same for the geothermal power system of the present invention displaying up to 6 years earlier to operation and income.

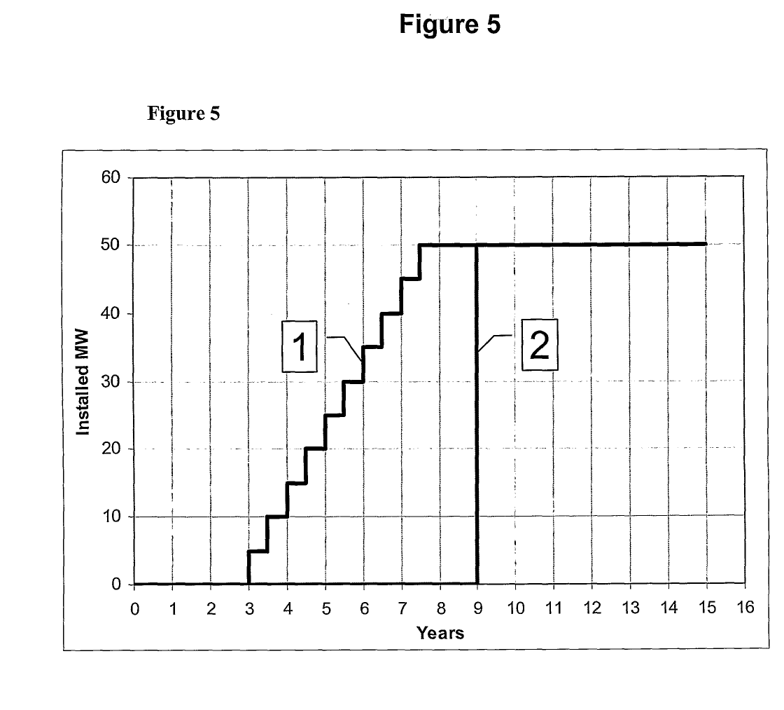

FIG. 5 illustrates the amount of earlier acquired income according to the invention (area between 1 and 2) compared to that of a conventional geothermal plant. The area in this calculation is 1500 GWh which means at European spot market energy prices of 2008 (65C=E/MW) an extra income according to the invention of 97.5 MillionC=but if using present German electricity prices for renewable energy would mean an extra income of 300 Million C=. This will pay back all on-surface investment which in case of FIG. 5 are 10 geothermal units during the advanced startup period.

1. Geothermal power plant, characterized in that it comprises units that are modularized and adapted in order to fit into one container, as a geothermal container unit,
and the geothermal container units are dimensioned in order to be adapted to extract geothermal energy from at least one drillbore, and
each geothermal container unit has means for being electrically connected to other geothermal container units as well as electric power network, thereby providing a geothermal power system arranged in a network providing load balancing and redundancy.

2. Geothermal power plant according to claim 1, further comprising
a steam/brine processing unit, operatively coupled to
a turbine/generator unit, operatively coupled to
a steam condensing unit, operatively coupled to
a cooling tower unit,

3. Geothermal power plant according to claim 1, characterized in that it comprise plurality geothermal container units, each unit placed on top of or in close vicinity to a drillbore (wellbore, borehole, drill hole) from which geothermal energy is extracted.

4. Geothermal power plant according to claim 1, characterized in that it is arranged in a peer-to-peer network comprising the geothermal power plant operator, the electric power network operator, vendors and the power company.
